(19) United States
(12) Patent Application Publication
(10) Pub. No.: US 2013/0033611 A1
(43) Pub. Date: Feb. 7, 2013

(54) Search System of Face Recognition and Method Thereof, Computer Readable Storage Media and Computer Program Product

(71) Applicant: Zhu Chen, Shanghai City (CN)

(72) Inventor: Zhu Chen, Shanghai City (CN)

(73) Assignees: MITAC RESEARCH (SHANGHAI) LTD., Shanghai (CN); MITAC INTERNATIONAL CORP., Kuei San Township (TW)

(21) Appl. No.: 13/218,032

(22) Filed: Aug. 25, 2011

(30) Foreign Application Priority Data
Aug. 1, 2011 (CN) 201110218637.4

(51) Int. Cl. H04N 5/225

(52) U.S. Cl. 348/207.1; 348/E05.024

(57) ABSTRACT

A search system of face recognition and a method thereof, a computer readable storage media and a computer program product. The search method of face recognition comprises of: capturing a human face image by an image capturing unit; recognizing a first face information of the human face image via a face recognition unit; controlling a first communication unit to transmit the first face information by a first processing unit; storing a plurality piece of personal information and a second face information corresponding to each personal information by a storage unit; comparing the first face information and the plurality piece of second face information by a matching unit; and controlling a second communication unit to provide the personal information corresponding to the second face information to a portable electronic device by a second processing unit when the first face information matches one of the second face information.

### BACKGROUND OF THE INVENTION

1. Field of the Invention

The present invention relates to a search system of face recognition and a method thereof, a computer readable storage media and a computer program product; in particular, it relates to a search system of face recognition enabling the consolidation of social networking services.

2. Description of Related Art

As technologies in portable devices become more and more mature, services offered through such devices also expand comprehensively. Social networking services based on the portable device increasingly represent the mainstream service in market.

At present, users can apply the portable electronic device to connect to and browse numerous so-called Social Networking Service (SNS) websites, such as Facebook, Twitter, Plurk, KaiXin001 or RenRen and the like, and buddies registered in such social networking websites are able to perform on-line communications, perspective exchanges, status updates or image sharing etc. with each other for the purposes of enjoyment, friendship and mutual communication.

However, the inventors of the present invention have considered the following issues: the social networks of modern people extend increasingly wider, but a friend well acquainted with on line may probably be unknown in real life and impossible to call his/her name even actually met; or alternatively, a good, old friend is encountered on the road but his/her name can not be remembered which may lead to an embarrassing situation; or still, a stranger may attract one's attention to get acquainted with and to look for further understanding about him/her but available approaches may be hard to come by; or further, someone intends to know more about surrounding people; unfortunately, all of which can be relatively difficult to be resolved so far.

With regards to the aforementioned issues, the inventors of the present invention have explored and designed a search system of face recognition and a method thereof, a computer readable storage media and a computer program product which can consolidate face images in real life and messages on social networking service websites and also use augmented reality (AR) technology to show the real-time social message conjunctively with the corresponding face image on the display screen of a portable electronic device thereby bringing more convenience and fun for daily lives. Thus industrial implementations and applications thereof can be facilitated as well.

### SUMMARY OF THE INVENTION

In view of the issues illustrated as above, one objective of the present invention is to provide a search system of face recognition and a method thereof, a computer readable storage media and a computer program product so as to resolve the issue of incapability for identifying someone's face promptly in real life and appreciating the corresponding social messages.

According to the objective of the present invention, a search system of face recognition is provided, comprising a portable electronic device and a server, in which the portable electronic device comprises a first processing unit, an image capturing unit, a first communication unit and a face recognition unit, and the server comprises a second communication unit, a storage unit, a matching unit and a second processing unit. After capturing a face image by the image capturing unit, the first processing unit controls the face recognition unit to recognize the first face information of the captured face image and transmits the first face information through the first communication unit. The storage unit stores a plurality pieces of personal information and the second face information corresponding to each piece of the plurality pieces of personal information. When the second communication unit receives the first face information, the second processing unit controls the matching unit to try to compare the first face information with the plurality pieces of second face information. In the event that the first face information matches one of the plurality pieces of second face information, the second processing unit controls the second communication unit to provide the personal information corresponding to the second face information to the portable electronic device.

Herein the portable electronic device further comprises a display unit and, after receiving the personal information by the first communication unit, the display unit shows the face image along with the personal information corresponding to the face image.

Herein the server further comprises a social networking service (SNS) website, in which the SNS website comprises, for example, Facebook, Twitter, Plurk or Myspace.

Herein the second processing unit further provides, in accordance with a user's authorization granted by the SNS website, the personal information conforming to the authorization to the portable electronic device

According to the objective of the present invention, a search method of face recognition is further provided. The search method of face recognition according to the present invention can be applied to a search system of face recognition. The search system of face recognition comprises a portable electronic device and a server, in which the portable electronic device comprises a first processing unit, an image capturing unit, a first communication unit and a face recognition unit, and the server comprises a second communication unit, a storage unit, a matching unit and a second processing unit. The search method of face recognition according to the present invention comprises the following steps: initially, capturing a face image by using an image capturing unit; recognizing the first face information of the face image through a face recognition unit, and controlling a first communication unit by means of a first processing unit to transmit the first face information. The method further comprises: storing a plurality pieces of personal information and the second face information corresponding to each piece of the plurality pieces of personal information by means of a storage unit. Thereafter, the method further comprises: comparing the first face information with the plurality pieces of second face information. In the event that the first face information matches one of the plurality pieces of second face information, controlling the second communication unit by the second processing unit to provide the personal information corresponding to the second face information to the portable electronic device.

Herein the search method of face recognition according to the present invention further comprises the following steps: receiving the personal information by the first communication unit; and showing the face image along with the personal information corresponding to the face image via a display unit.

Herein the server further comprises a social networking service (SNS) website, in which the SNS website comprises, for example, Facebook, Twitter, Plurk or Myspace.

Herein the search method of face recognition according to the present invention further comprises the step of providing, in accordance with a user's authorization granted by the SNS website, the personal information conforming to the authorization to the portable electronic device through the second processing unit.

According to the objective of the present invention, a computer readable storage media is also provided, which comprise a program code that, upon being loaded and executed by a processor, is capable of completing the steps for the aforementioned search method of face recognition according to the present invention.

According to the objective of the present invention, a computer program product is further provided, which comprises a program code that, upon being loaded and executed by a processor, is capable of completing the steps for the aforementioned search method of face recognition according to the present invention.

In summary of the above-said descriptions, a search system of face recognition and a method thereof, a computer readable storage media and a computer program product according to the present invention can advantageously combine the augmented reality (AR) technology, face identification technology as well as social networking service (SNS) technology thereby assisting the user to transmit the personal information corresponding to a face image to a portable electronic device by means of social messaging technology, so as to enable fast identification of a person of interest by the user.

### BRIEF DESCRIPTION OF THE DRAWINGS

FIG. 1 shows a diagram for a search system of face recognition according to the present invention;

FIG. 2 shows a diagram for an embodiment of a search system of face recognition according to the present invention; and

FIG. 3 shows a step-wise flowchart for a search method of face recognition according to the present invention.

### DETAILED DESCRIPTION OF THE PREFERRED EMBODIMENTS

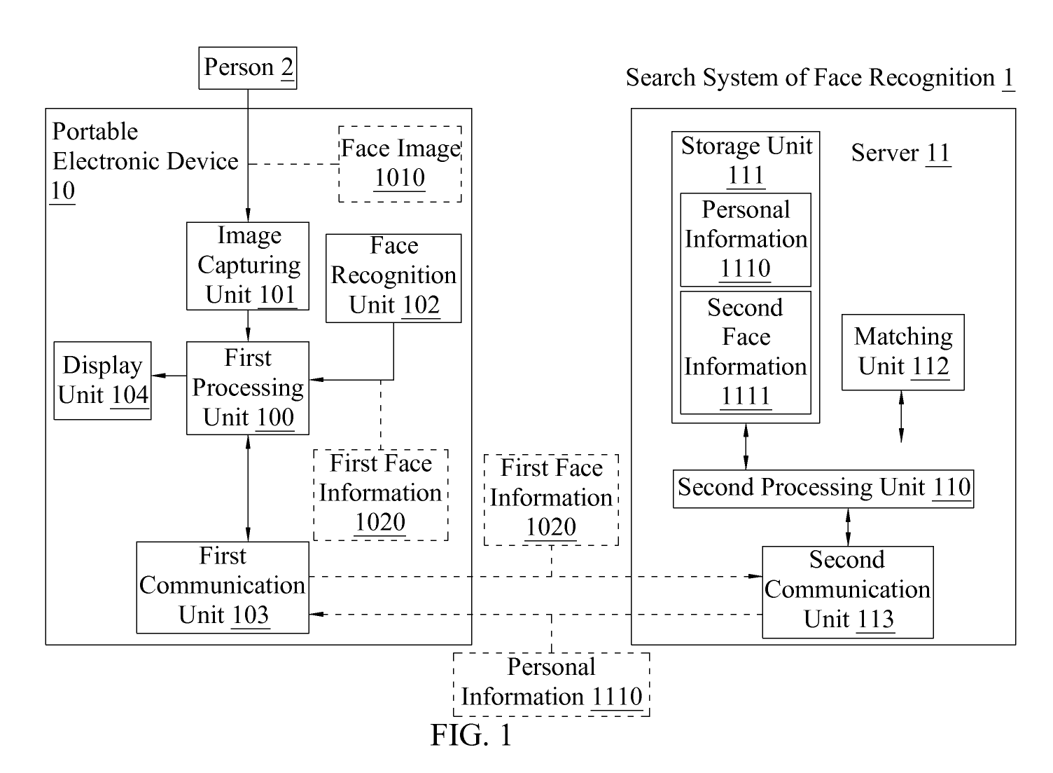

Refer first to FIG. 1, wherein a diagram for a search system of face recognition according to the present invention is shown. As shown in the figure, the search system of face recognition 1 according to the present invention comprises a portable electronic device 10 and a server 11. Herein the portable electronic device 10 comprises a first processing unit 100 respectively and electrically connected to an image capturing unit 101, a face recognition unit 102, a first communication unit 103 and a display unit 104; on the other hand, the server 11 comprises a second processing unit 110 respectively and electrically connected to a storage unit 111, a matching unit 112 as well as a second communication unit 113. Herein the face recognition unit 102 or the matching unit 112 may be an individual and independent chip; the first processing unit 100 or the second processing unit 110 may be an independent central processing unit or a microprocessor, but not limited thereto.

The storage unit 111 can be various kinds of storage media, such as the embedded memory, external memory (card), diskette or compact disc (CD), and store a plurality pieces of personal information 1110 and the second face information 1111 corresponding to each piece of the plurality pieces of personal information. Herein the personal information 1110 may comprise items like the name, age, gender, academic degree, nationality, location of residence, real-time status or most recent response and so forth, or a combination thereof. When a user holds a portable electronic device 1, it is possible to take pictures of a person 2 to be recognized with the image capturing unit 101, thereby capturing the face image 1010 of such a person 2. Herein the image capturing unit 101 may be, such as, a video recorder, a camera or an electronic device enabling the image capturing functions.

Next, the face recognition unit 102 uses the face recognition program to recognize the first face information 1020 of the face image 1010. Herein the first face information 1020 can be the characteristics on human faces; for example, at least one of the end of eyebrow, the tip of nose, the inner corner of eye, the outer corner of eye and the corner of mouth etc., but not limited thereto. After recognition of the face image 1010 by the face recognition unit 102 and provision of the first face information 1020 corresponding to the face image 1010, the first processing unit 100 controls the first communication unit 103 to transmit the first face information 1020 to the server 11. Then the server 11 may employ the second communication unit 113 to receive the first face information 1020. Herein the communication between the portable electronic device 10 and the server 11 can be performed by means of the first communication unit 103 and the second communication unit 113 via the network, in which the network may comprise telecommunication networks, wired or wireless networks.

Afterward, when the server 11 receives the first face information 1020, the second processing unit 110 controls the matching unit 112 to compare the first face information 1020 with the plurality pieces of second face information 1111. Wherein, when it is determined that the first face information 1020 indeed matches one of the plurality pieces of second face information 1111 by the matching unit 112, the second processing unit 110 searches and locates the personal information 1110 corresponding to the second face information 1111 and controls the second communication unit 113 to transmit the personal information 1110 to the portable electronic device 10.

Upon receiving the personal information 1110 by the first processing unit 100 through the first communication unit 103, the first processing unit 100 controls the display unit 104 to show the face image 1010 along with the personal information 1110, thus allowing the user to appreciate the identity of the person 2 on the display unit 104, so as to achieve the purpose of fast identity recognition.

Herein the display unit 104 can be various kinds of display devices; e.g., a liquid crystal screen, a projector, an organic light emitting diode (OLED) display or an e-paper, to name a few.

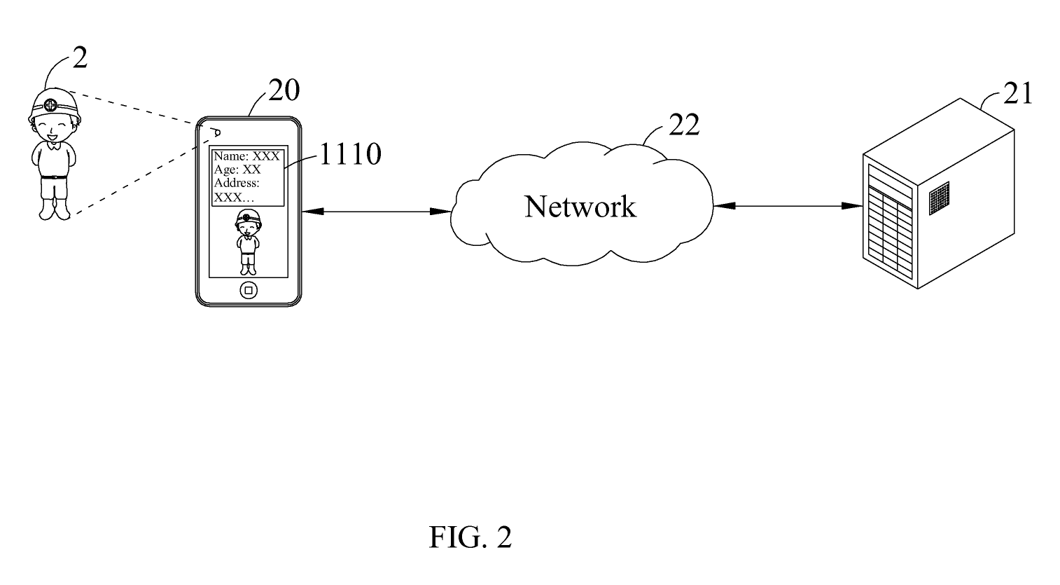

Refer next to FIG. 2, wherein a diagram for an embodiment of the search system of face recognition according to the present invention is shown. As shown in the figure, the portable electronic device is exemplarily implemented with a personal digital assistant (PDA) 20 and the server can be embodied with a social networking server 21. The illustrated social networking server 21 further provides a social networking service (SNS) website, in which the SNS website may comprise the website of, for example, Facebook, Twitter, Plurk or Myspace, or a combination thereof. A user can apply the web cam installed on the PDA 20 to take pictures of a person 2 which needs to be recognized and provide the face image, in which the PDA 20 analyzes the face image to recognize the first face information of the face image and then transmits the first face information to the social networking server 21. After reception of the first face information by the social networking server 21, it compares the first face information with a plurality pieces of second face information. It should be noted that, the social networking server 21 provides many interactive channels for various communications and contacts through services like real-time messaging, discussion group, e-mail function, on-line chat room or video sharing and so on, and also offers different services to users having different authorities; for example, the host of a fan club may have an authority higher than the one of general club members; e.g., the personal information that a host can review may be more detailed and complete than a general club member can browse. In case that the social networking server 21 finds the first face information does match one of the plurality pieces of second face information, the social networking server 21 searches the personal information corresponding to the located second face information and transmits the personal information to the PDA 20 via the network 22. Subsequently, on the PDA 20, it is possible to simultaneously display the face image and the personal information. Therefore, the user can efficiently and in a real-time fashion find the personal information corresponding to the face image from the social networking server 21 through the network 22 with the user's portable electronic device 20. Then, present the personal information of interest on the display screen so as to consolidate the face recognition function and the social networking server in order to achieve the purpose of convenient face recognition and rapid acquisition of person information corresponding to the face of interest.

In addition, although the aforementioned embodiment is identified with one single face to provide the presentation of the corresponding personal information, those skilled ones in the art, however, can arbitrarily adjust the number of faces based on the user's settings.

Although the concepts about the search system of face recognition according to the present invention have been set forth along with the descriptions on the search method of face recognition according to the present invention, to facilitate more thorough understanding, a flowchart thereof is additionally depicted hereunder for more detailed explanations.

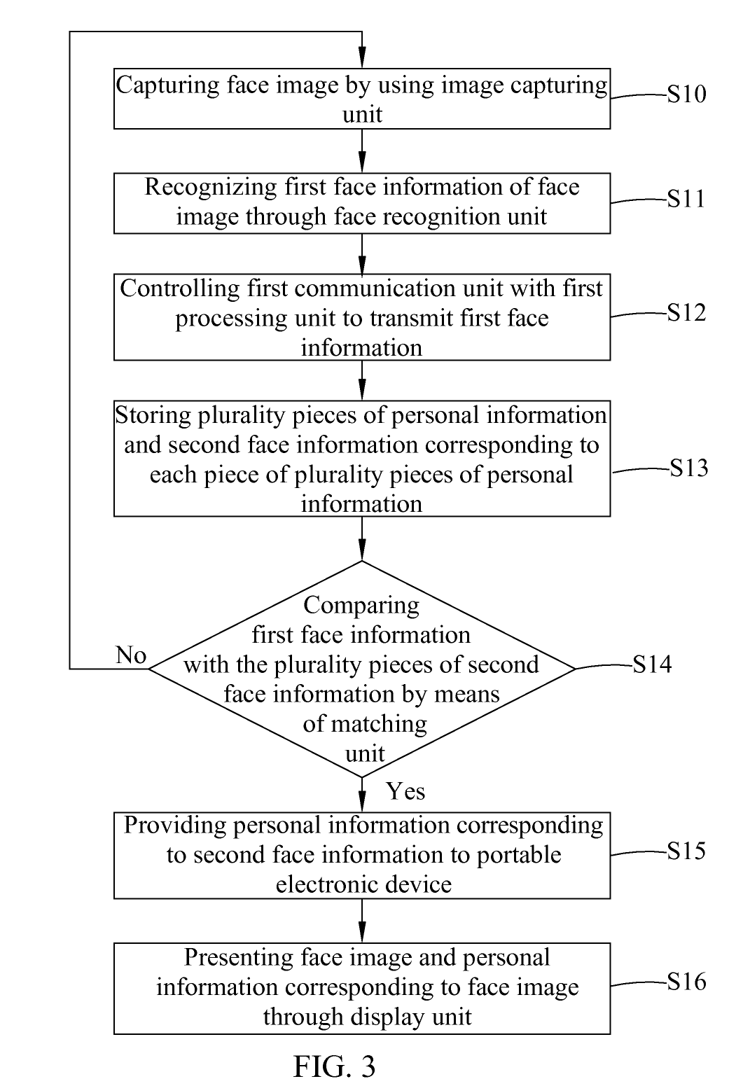

Refer next to FIG. 3, wherein a step-wise flowchart for a search method of face recognition according to the present invention is shown. As shown in the figure, the search method of face recognition according to the present invention comprises the following steps:

(S10) capturing a face image by using an image capturing unit;

(S11) recognizing the first face information of the face image through a face recognition unit;

(S12) controlling a first communication unit with a first processing unit to transmit the first face information;

(S13) storing a plurality pieces of personal information and the second face information corresponding to each piece of the plurality pieces of personal information by means of a storage unit;

(S14) comparing the first face information with the plurality piece of second face information by means of a matching unit, and in case the first face information matches one of the plurality pieces of second face information, then performing STEP (S15), otherwise performing STEP (S10);

(S15) controlling a second communication unit with a second processing unit to provide the personal information corresponding to the second face information to the portable electronic device; and

(S16) showing the face image and the personal information corresponding to the face image through a display unit.

Herein the STEP (S13) can be preferably performed before the STEP (S10), but the present invention is not limited to any specific sequence of executions thereof.

Furthermore, the search method of face recognition according to the present invention further comprises a step of providing a social networking service (SNS) website with the server, in which the SNS website comprises, for example, Facebook, Twitter, Plurk, Myspace, RenRen or KaiXin001 and other similar websites. In continuation of the aforementioned steps, the search method of face recognition according to the present invention further comprises the step of providing, in accordance with a user's authorization granted by the SNS website, the personal information conforming to the authorization to the portable electronic device through the second processing unit.

The detailed descriptions concerning the component functions and actions in each of the above-said steps can be analogously referred to the illustrations on the search system of face recognition according to the present invention, which are herein omitted for brevity.

The preferred embodiments of the present invention are described as above. In addition to the instances as illustrated in such preferred embodiments, all of the aforementioned units can be effectively implemented by means of software, hardware components or a combination thereof, and can operate conjunctively with any required firmware components. Besides, the search system of face recognition according to the present invention can be embodied by means of a storage media as well. Said storage medium may be a compact disc (CD), a hard disc drive, a Flash drive or other similar storage device carrying the program code therein, in which the program code, upon being read and executed by a processor, can perform the search method of face recognition comprising the aforementioned steps (S10)˜(S16). On the other hand, the present invention can be also implemented by using a computer program product. Said computer program product carries the program code thereon, which, upon being read and executed by a processor, can complete the method described in the previous embodiments of the present invention. Optionally, the computer program product can be transferred through networks or other approaches.

In summary, a search system of face recognition and a method thereof, a computer readable storage media and a computer program product according to the present invention provides at least the following advantages:

1. it is possible to eliminate the defect of prior art concerning difficulties in searching the social messages (e.g., personal information, real-time status or most recent response) corresponding to a face image at a social networking website by using the face image;

2. the personal information corresponding to the face image can be successfully identified through the consolidation of the face recognition technology and the social networking database to present the face image and the personal information thereof in order to offer the benefits of the augment reality and fast identification.

The aforementioned descriptions are exemplary rather than being restrictive. All effectively equivalent changes, alternation or substitutions made thereto without departing from the spirit and scope of the present invention are deemed to be encompassed by the present invention as delineated in the following claims.

What is claimed is:

1. A search system of face recognition, comprising:
a portable electronic device, comprising:
a first processing unit;
an image capturing unit connected to the first processing unit and capturing a face image;
a face recognition unit connected to the first processing unit and recognizing first face information of the face image; and
a first communication unit connected to the first processing unit and transmitting the first face information; and
a server, comprising:
a second communication unit arranged for receiving the first face information;
a storage unit storing a plurality pieces of personal information and second face information corresponding to each piece of the plurality of personal information;
a matching unit comparing the first face information with the plurality pieces of second face information; and
a second processing unit connected to the second communication unit, the storage unit and the matching unit, wherein when it is determined that the first face information matches one of the plurality pieces of second face information by the matching unit, the second processing unit controls the second communication unit to provide the personal information corresponding to the second face information to the portable electronic device.

2. The search system of face recognition according to claim 1, wherein the first communication unit further receives the personal information, and the portable electronic device further comprises a display unit connected to the first processing unit and presenting the face image and the personal information corresponding to the face image.

3. The search system of face recognition according to claim 1, wherein the server further comprises a social networking service (SNS) website.

4. The search system of face recognition according to claim 3, wherein the second processing unit further provides, in accordance with a user's authorization granted by the SNS website, the personal information conforming to the authorization to the portable electronic device.

5. A search method of face recognition applicable to a search system of face recognition comprising a portable electronic device and a server, in which the portable electronic device comprises a first processing unit, an image capturing unit, a first communication unit and a face recognition unit, and the server comprises a second communication unit, a storage unit, a matching unit and a second processing unit, the method comprising the following steps:
capturing a face image by using the image capturing unit;
recognizing first face information of the face image through the face recognition unit;
controlling the first communication unit with the first processing unit to transmit the first face information;
storing a plurality pieces of personal information and second face information corresponding to each piece of the plurality of personal information by means of the storage unit;
comparing the first face information with the plurality pieces of second face information by using the matching unit; and
controlling the second communication unit by the second processing unit to provide the personal information corresponding to the second face information to the portable electronic device while it is determined that the first face information matches one of the plurality pieces of second face information.

6. The search method of face recognition according to claim 5, further comprising:
receiving the personal information with the first communication unit; and
showing the face image and the personal information corresponding to the face image through a display unit.

7. The search method of face recognition according to claim 5, wherein the server further comprises a social networking service (SNS) website.

8. The search method of face recognition according to claim 7, further comprising a step of providing, in accordance with a user's authorization granted by the SNS website, the personal information conforming to the authorization to the portable electronic device by means of the second processing unit.

9. A computer readable storage media, comprising a program code which, upon being loaded and executed by a processor, is capable of completing the search method of face recognition according to claim 5.

10. A computer program product, comprising a program code which, upon being loaded and executed by a processor, is capable of completing the search method of face recognition according to claim 5.
